(19) United States
(12) Patent Application Publication
(10) Pub. No.: US 2019/0350161 A1
(43) Pub. Date: Nov. 21, 2019

(54) METHOD AND APPARATUS FOR MANUFACTURING WATER ABSORPTION TREATMENT MATERIAL

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 16/530,119

(22) Filed: Aug. 2, 2019

Related U.S. Application Data
(63) Continuation of application No. PCT/JP2018/005082, filed on Feb. 14, 2018.

(30) Foreign Application Priority Data
Apr. 13, 2017 (JP) 2017-079356

(51) Int. Cl. A01K 1/015; B01J 2/20; B01J 20/32

(52) U.S. Cl. CPC A01K 1/015; B01J 20/32; B01J 2/20

(57) ABSTRACT

A manufacturing apparatus is an apparatus for manufacturing a water absorption treatment material that is composed of a plurality of grains, and includes a granulation machine and a coating machine. The granulation machine granulates a granulation material and thereby forms a granule (core portion) that constitutes each of the grains The coating machine attaches a coating material that contains an adhesive material to a surface of the core portion formed by the granulation machine, and thereby forms a coating portion that covers the surface of the core portion. The granulation machine forms the core portion that has a through hole that extends through the core portion.

### CROSS REFERENCE TO RELATED APPLICATION

This is a Continuation of International Application No. PCT/JP2018/005082 filed Feb. 14, 2018, which claims the benefit of Japanese Application No. 2017-079356 filed Apr. 13, 2017. The contents of these applications are hereby incorporated by reference in their entirety.

### TECHNICAL FIELD

The present invention relates to a method and an apparatus for manufacturing a water absorption treatment material that absorbs a liquid.

### BACKGROUND ART

Patent Document 1 discloses an excrement treatment material that is a kind of water absorption treatment material. The excrement treatment material disclosed in the document is composed of a plurality of grains that absorb urine. Each grain includes a granular core portion that has water absorbing properties and a coating portion that covers the core portion. The coating portion contains an adhesive material, and has a function of bonding grains that have absorbed urine together.

### CITATION LIST

### Patent Document

Patent Document 1: JP 2007-190026 A

### SUMMARY OF INVENTION

### Technical Problem

With the excrement treatment material described above, a clump is obtained that is composed of a plurality of grains that have absorbed urine. By discarding the clump of grains, urine can also be disposed of together with the grains. As described above, by causing the water absorption treatment material to absorb a liquid, the liquid can be easily disposed of. However, there is still room for improvement in the conventional water absorption treatment material in terms of water absorption speed.

### Solution to Problem

The present invention has been made in view of the problem described above, and it is an object of the present invention to provide a method and an apparatus for manufacturing a water absorption treatment material that has an excellent water absorption speed.

A method for manufacturing a water absorption treatment material according to the present invention is a method for manufacturing a water absorption treatment material that is composed of a plurality of grains, the method including; a granulation step of granulating a granulation material, and thereby forming a granule that constitutes each of the grains; and a coating step of attaching a coating material that contains an adhesive material to a surface of the granule formed in the granulation step, and thereby forming a coating portion that covers the surface of the granule, wherein, in the granulation step, the granule that has a through hole that extends therethrough is formed.

In the manufacturing method, a granule that has a through hole is formed in the granulation step. Accordingly, a grain that has a surface area larger than that of when a through hole is not formed in the granule is obtained. As a result, the contact area of the grain that comes into contact with a liquid is increased, and thus the water absorption speed can be improved.

Also, an apparatus for manufacturing a water absorption treatment material according to the present invention is an apparatus for manufacturing a water absorption treatment material that is composed of a plurality of grains, the apparatus including: a granulation machine that granulates a granulation material and thereby forms a granule that constitutes each of the grains; and a coating machine that attaches a coating material that contains an adhesive material to a surface of the granule formed by the granulation machine, and thereby forms a coating portion that covers the surface of the granule, wherein the granulation machine forms the granule that has a through hole that extends therethrough.

In the manufacturing apparatus, a granule that has a through hole is formed by the granulation machine. Accordingly, a grain that has a surface area larger than that of when a through hole is not formed in the granule is obtained. As a result, the contact area of the grain that comes into contact with a liquid is increased, and thus the water absorption speed can be improved.

### Advantageous Effects of Invention

According to the present invention, it is possible to implement a method and an apparatus for manufacturing a water absorption treatment material that has an excellent water absorption speed.

### BRIEF DESCRIPTION OF DRAWINGS

FIG. 1 is a schematic diagram showing a water absorption treatment material according to an embodiment of the present invention.

FIG. 2 is a perspective view of a grain 30.

FIG. 3 is a cross sectional view taken along a line III-III shown in FIG. 2.

FIG. 4 is a perspective view of a core portion 32.

FIG. 5 is a diagram showing a configuration of an apparatus for manufacturing a water absorption treatment material according to an embodiment of the present invention.

FIG. 6 is a plan view of a granulation machine 10.

FIG. 7 is a bottom view of the granulation machine 10.

FIG. 8 is a diagram showing a portion of an end face taken along a line VIII-VIII shown in FIG. 6.

FIG. 9 is an enlarged view of a die hole 13 shown in FIG. 6.

FIG. 10 is a diagram illustrating a granulation step of a method for manufacturing a water absorption treatment material according to an embodiment of the present invention.

FIG. 11 is a diagram illustrating the granulation step of the method for manufacturing a water absorption treatment material according to the embodiment of the present invention.

FIG. 12 is a diagram illustrating an end face of a core member 18 according to a variation.

FIG. 13 is a diagram illustrating an end face of a core member 18 according to another variation.

FIG. 14 is a plan view illustrating die holes 13 according to a variation.

### DESCRIPTION OF EMBODIMENTS

Hereinafter, an embodiment of the present invention will be described in detail with reference to the drawings. In the description of the drawings, the same elements are given the same reference numerals, and redundant descriptions thereof will be omitted.

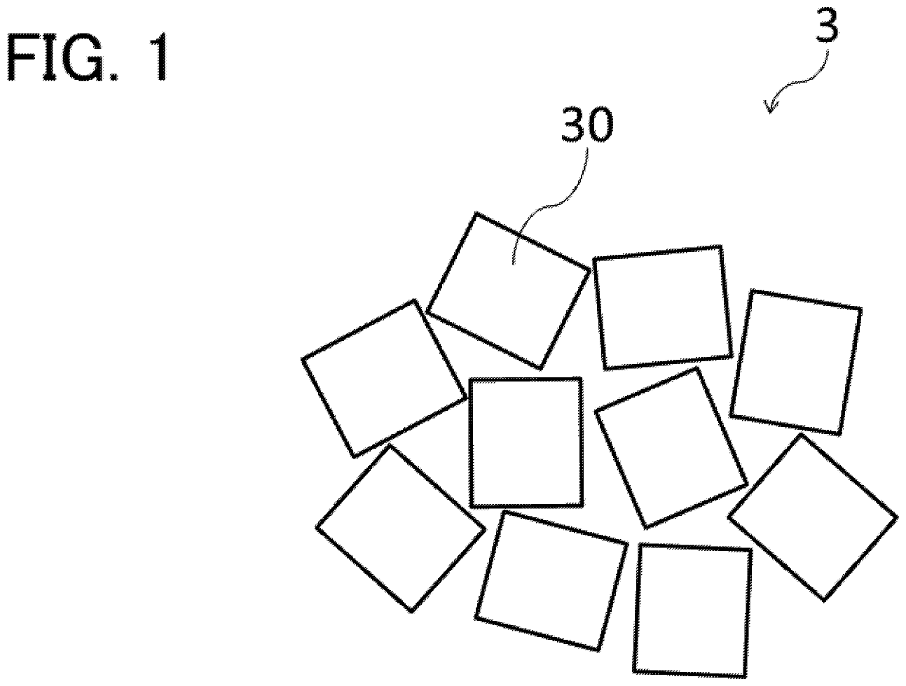

FIG. 1 is a schematic diagram showing a water absorption treatment material according to an embodiment of the present invention. A water absorption treatment material 3 is composed of a plurality of grains 30. Each grain 30 has water absorbing properties, and absorbs a liquid that is to be disposed. The grains 30 are configured so as to bond to each other upon absorbing a liquid. The water absorption treatment material 3 is used as, for example, an excrement treatment material that absorbs human or animal excrement for disposal.

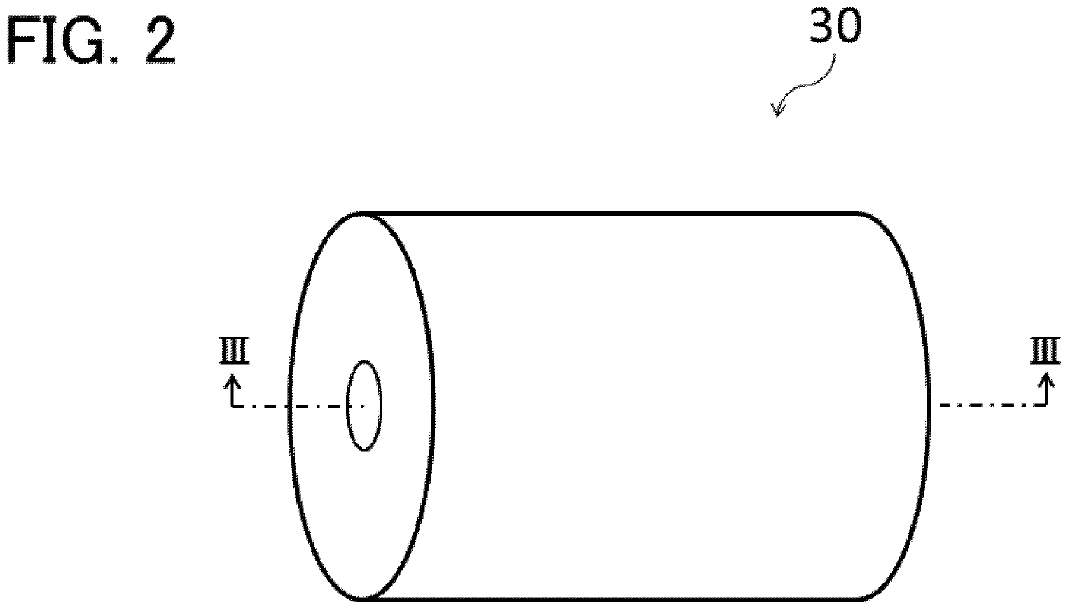

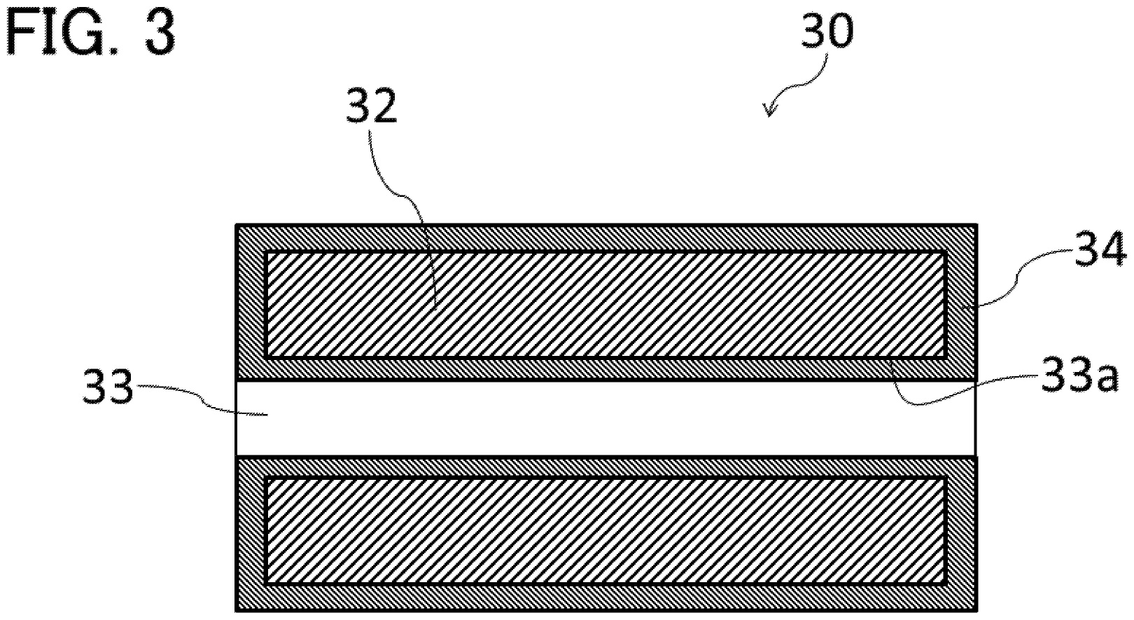

FIG. 2 is a perspective view of a grain 30. FIG. 3 is a cross sectional view taken along a line III-III shown in FIG. 2. The grain 30 includes a core portion 32 (granule) and a coating portion 34.

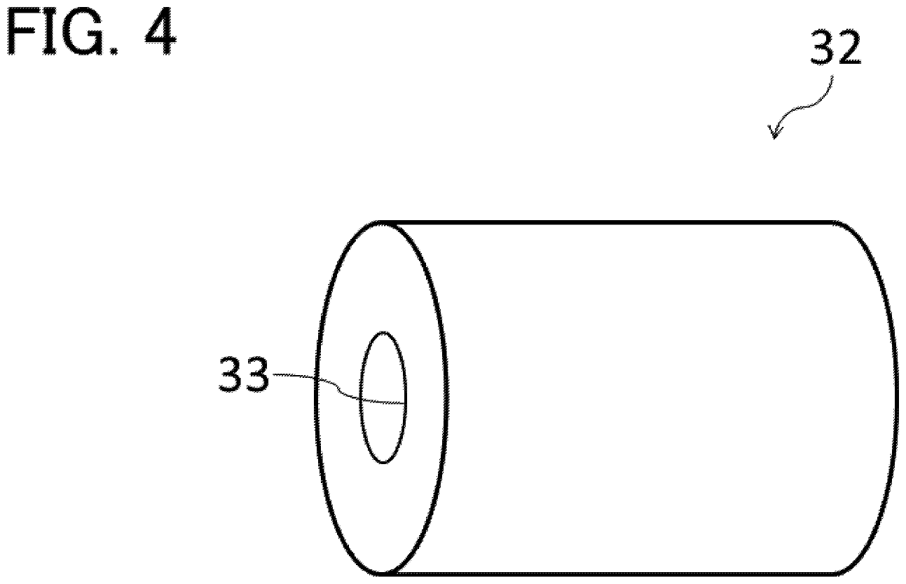

FIG. 4 is a perspective view of a core portion 32. The core portion 32 has a substantially cylindrical tubular shape. In other words, the core portion 32 has a cylindrical shape in which a through hole 33 extending along the central axis is formed. The through hole 33 extends through the core portion 32. As a result, a substantially cylindrical space identical with the through hole 33 is present within the core portion 32.

The core portion 32 has a function of absorbing and retaining a liquid. The main material of the core portion 32 is preferably an organic substance. As used herein, the main material of the core portion 32 refers to one of the materials constituting the core portion 32 that accounts for the highest proportion by weight in the core portion 32. It is possible to use, for example, papers, used tea leaves, plastics, or soybean refuse as the organic substance.

Papers refer to a material composed mainly of pulp. Examples of papers include ordinary paper, a vinyl chloride wallpaper classified product (paper obtained by classifying vinyl chloride wallpaper), fluff pulp, papermaking sludge, pulp sludge, and the like. As the plastics, it is possible to use, for example, a disposable diaper classified product (plastics obtained by classifying disposable diapers). The soybean refuse is preferably dried soybean refuse.

Referring back to FIG. 3, the coating portion 34 covers the surface of the core portion 32. The coating portion 34 also covers an inner face 33a of the through hole 33 of the core portion 32. The inner face 33a of the through hole 33 constitutes a portion of the surface of the core portion 32. In the present embodiment, the entire inner face 33a of the through hole 33 and the entire surface of the core portion 32 are covered by the coating portion 34. Also, the coating portion 34 is provided so as not to close the through hole 33. In other words, the entire internal space of the core portion 32 is kept continuous.

The coating portion 34 has a function of bonding grains 30 that have absorbed a liquid and forming them into a clump. The main material of the coating portion 34 is also preferably an organic substance. The coating portion 34 contains an adhesive material. As the adhesive material, it is possible to use, for example, starch, CMC (carboxymethyl cellulose), PVA (polyvinyl alcohol), dextrin, or a water-absorbent polymer.

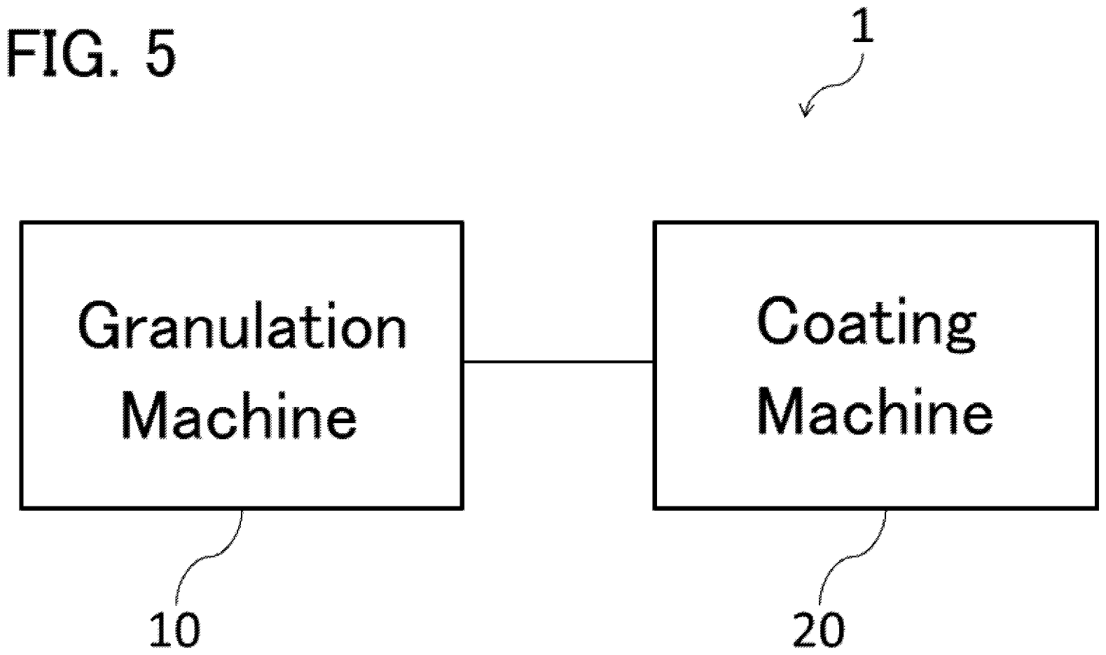

FIG. 5 is a diagram showing a configuration of an apparatus for manufacturing a water absorption treatment material according to an embodiment of the present invention. A manufacturing apparatus 1 is an apparatus for manufacturing the above-described water absorption treatment material 3. The manufacturing apparatus 1 includes a granulation machine 10 and a coating machine 20. The granulation machine 10 is a machine for forming granules (core portions 32) by granulating a granulation material (a material for forming the core portions 32). The granulation machine 10 forms a core portion 32 that has a through hole 33. In the present embodiment, the granulation machine 10 is an extrusion granulation machine.

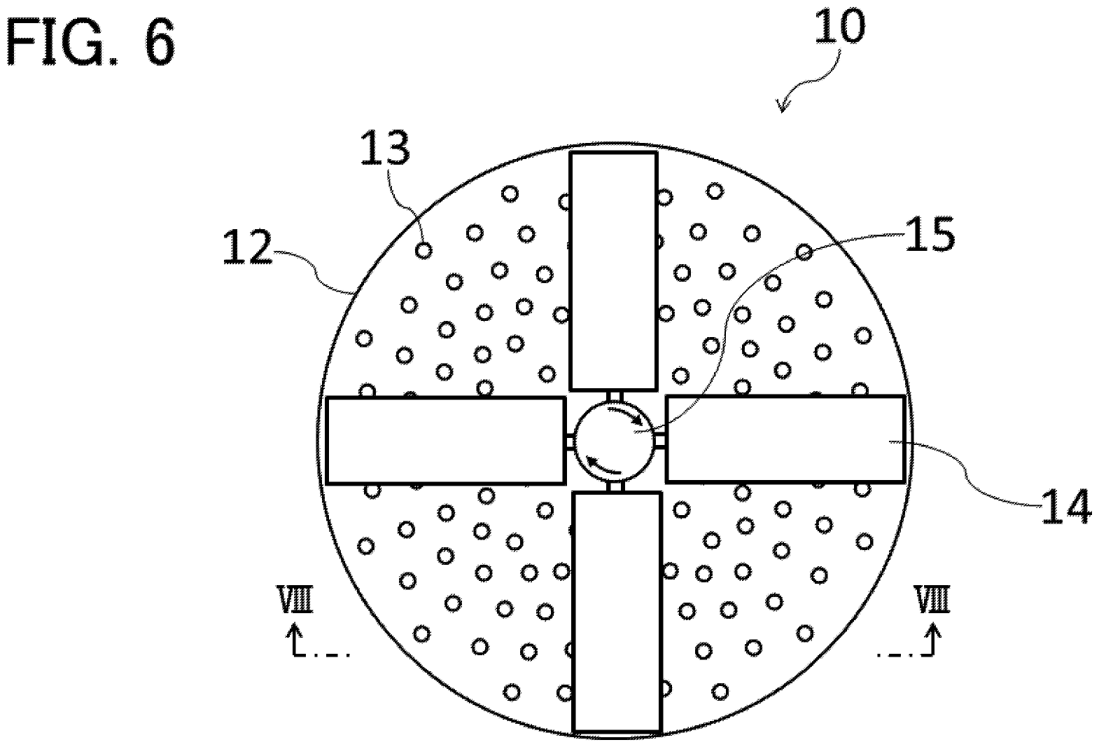

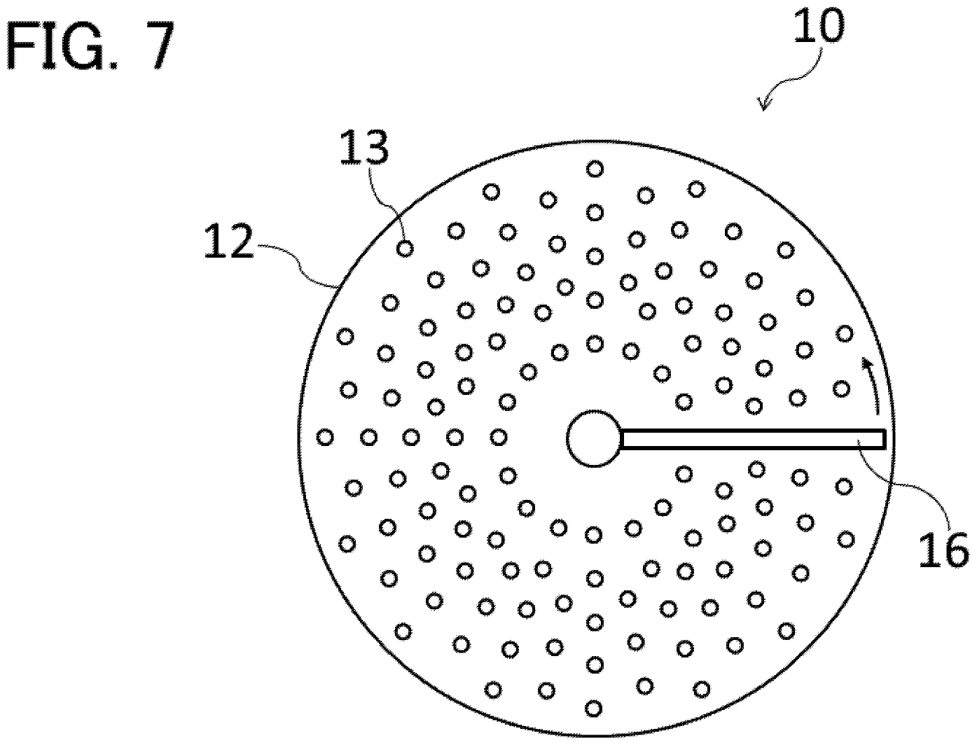

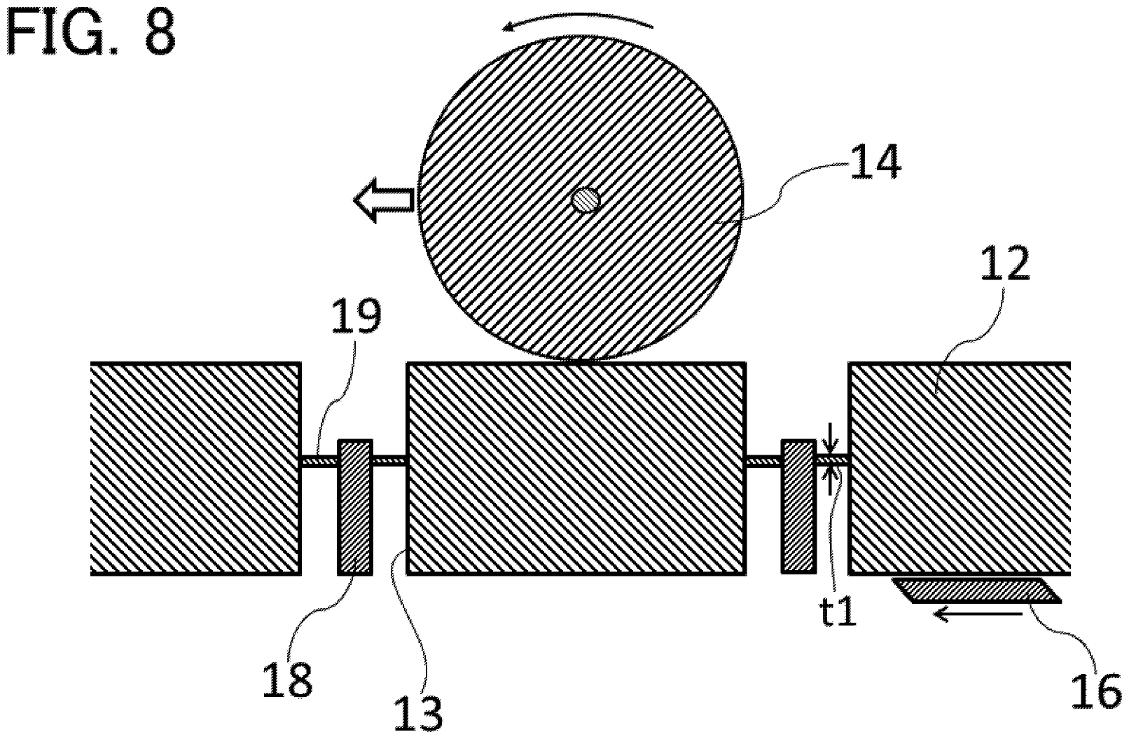

FIG. 6 is a plan view of the granulation machine 10, and FIG. 7 is a bottom view of the granulation machine 10. Also, FIG. 8 is a diagram showing a portion of an end face taken along a line VIII-VIII shown in FIG. 6. The granulation machine 10 includes a die 12, a roller 14, and a cutter 16. In the die 12, a plurality of die holes 13 that allow the granulation material to pass therethrough are formed. Each die hole 13 has a circular shape when viewed in a plan view. The plurality of die holes 13 are distributed substantially over the entire surface of the die 12.

As shown in FIG. 6, the front surface side of the die 12 (the inlet side of the die holes 13) is provided with a roller 14. The roller 14 has a cylindrical shape, and its central axis extends in the radial direction of the die 12. In the present embodiment, a plurality of (specifically, four) rollers 14 are provided. One end of each roller 14 is connected to a rotation axis 15 positioned at a center portion of the front surface of the die 12. The rollers 14 press the granulation material into each of the die holes 13 while revolving about the rotation axis 15. In the present embodiment, each roller 14 revolves about the rotation axis 15 while rotating on its central axis. The rollers 14 can pass over all of the die holes 13 formed in the die 12.

As shown in FIG. 7, the back surface side of the die 12 (the outlet side of the die hole 13) is provided with a cutter 16. The cutter 16 extends in the radial direction of the die 12 from a center portion of the back surface of the die 12. The cutter 16 cuts the granulation material that has been extruded from the die holes 13 while rotating along the back surface of the die 12. To be specific, the cutter 16 rotates about the center portion of the die 12 within a plane that is parallel to the back surface of the die 12. The cutter 16 is configured to be capable of rotating independently of the roller 14 described above. The cutter 16 can pass over all of the die holes 13 formed in the die 12.

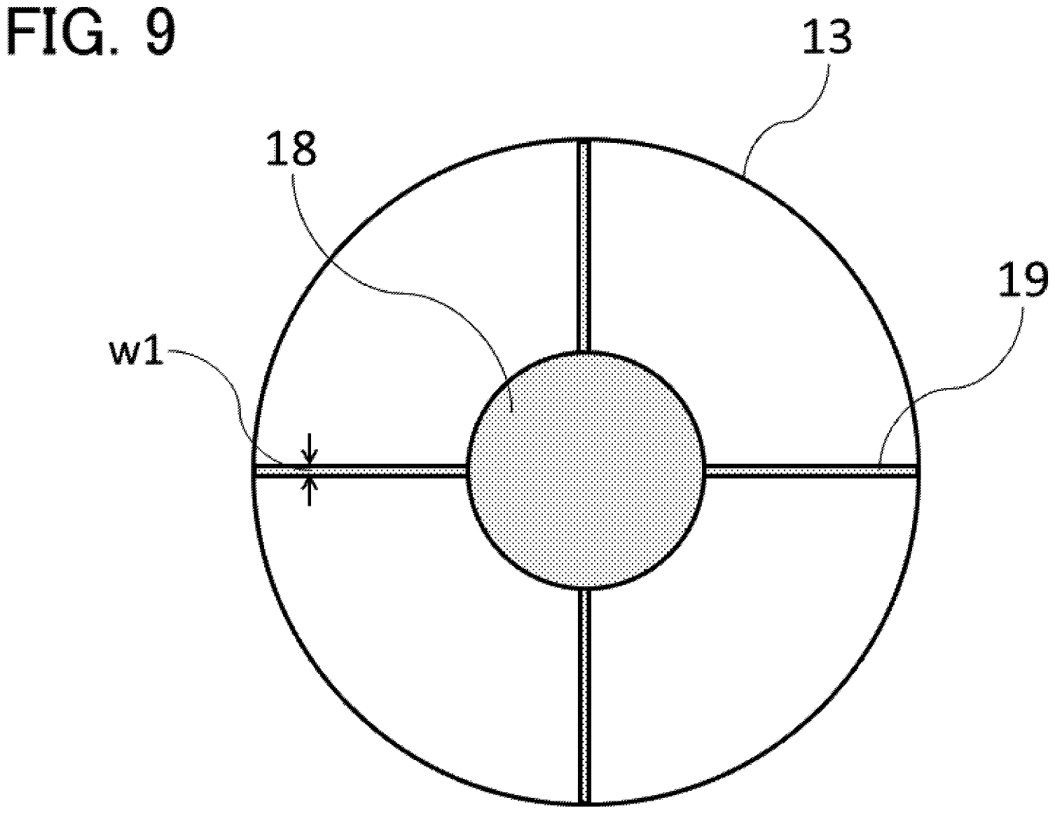

FIG. 9 is an enlarged view of a die hole 13 shown in FIG. 6. The die hole 13 is internally provided with a core member 18. The core member 18 is provided at a position spaced apart from the inner face of the die hole 13. The core member 18 has a round rod shape (cylindrical shape), and extends along the central axis of the die hole 13. The central axis of the core member 18 matches the central axis of the die hole 13. The diameter of the core member 18 is, for example, greater than or equal to one fourth of the diameter of the die hole 13 and less than or equal to one half of the same. The core member 18 is fixed to the die hole 13 via a connecting member 19. The connecting member 19 extends along the radial direction of the die hole 13 from the core member 18 to the inner face of the die hole 13. In other words, one end of the connecting member 19 is connected to a side face of the core member 18, and the other end of the connecting member 19 is connected to the inner face of the die hole 13. The connecting member 19 has a width w1 that is smaller than the diameter of the core member 18. The width w1 of the connecting member 19 is preferably as small as possible as long as it is possible to support the core member 18 during granulation.

As can be seen from FIG. 8, the core member 18 is provided so as to extend only partially through the die hole 13 in the thickness direction of the die 12 (in the up-down direction in the diagram). The core member 18 extends to the outlet opening surface of the die hole 13, but does not extend to the inlet opening surface of the die hole 13. Also, the connecting member 19 is provided at a position closer to an upper end of the core member 18 rather than a lower end of the core member 18. The connecting member 19 has a thickness t1 that is smaller than the length of the core member 18. The thickness t1 of the connecting member 19 is also preferably as small as possible as long as it is possible to support the core member 18 during granulation. As the material for forming the core member 18 and the connecting member 19, for example, a metal or a plastic can be used. In FIGS. 6 and 7, the core member 18 and the connecting member 19 are not shown.

Referring back to FIG. 5, the coating machine 20 is a machine for forming coating portions 34 that cover the surface of the core portions 32 formed by the granulation machine 10. The coating machine 20 forms a coating portion 34 by attaching a powdered coating material (a material for forming the coating portion 34) to the surface of each core portion 32. The attachment of the coating material may be performed by, for example, sprinkling or spraying the coating material. The coating material contains an adhesive material. The coating machine 20 also attaches the coating material to the inner face 33a of the through hole 33 of the core portion 32. At this time, the coating machine 20 attaches the coating material to the inner face of the through hole 33 so as not to close the through hole 33. Also, the coating machine 20 attaches the coating material to the entire inner face 33a of the through hole 33.

Next, a method for manufacturing a water absorption treatment material according to an embodiment of the present invention will be described in conjunction with the operations of the manufacturing apparatus 1. The manufacturing method includes a granulation step and a coating step. The granulation step is a step of forming granules (core portions 32) by granulating a granulation material. In this step, the granulation machine 10 described above is used to form the core portions 32 that each have a through hole 33. Prior to granulation, the granulation material is subjected to pre-treatment such as pulverization, kneading, and adding water, as needed.

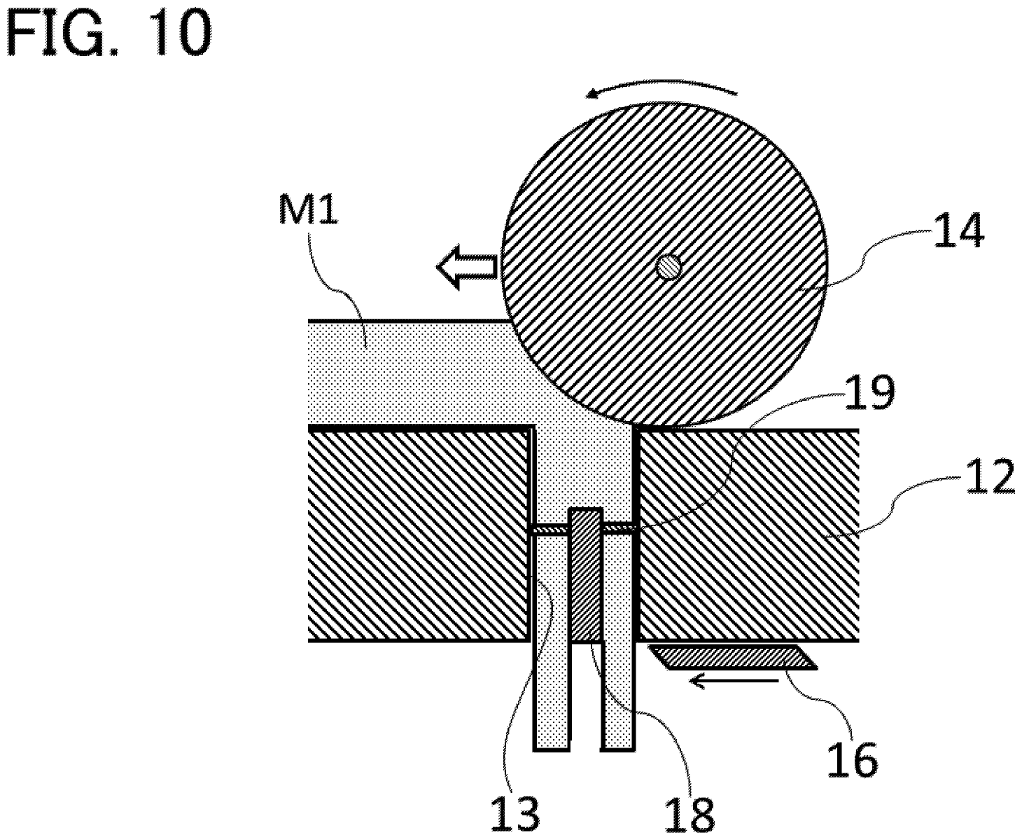

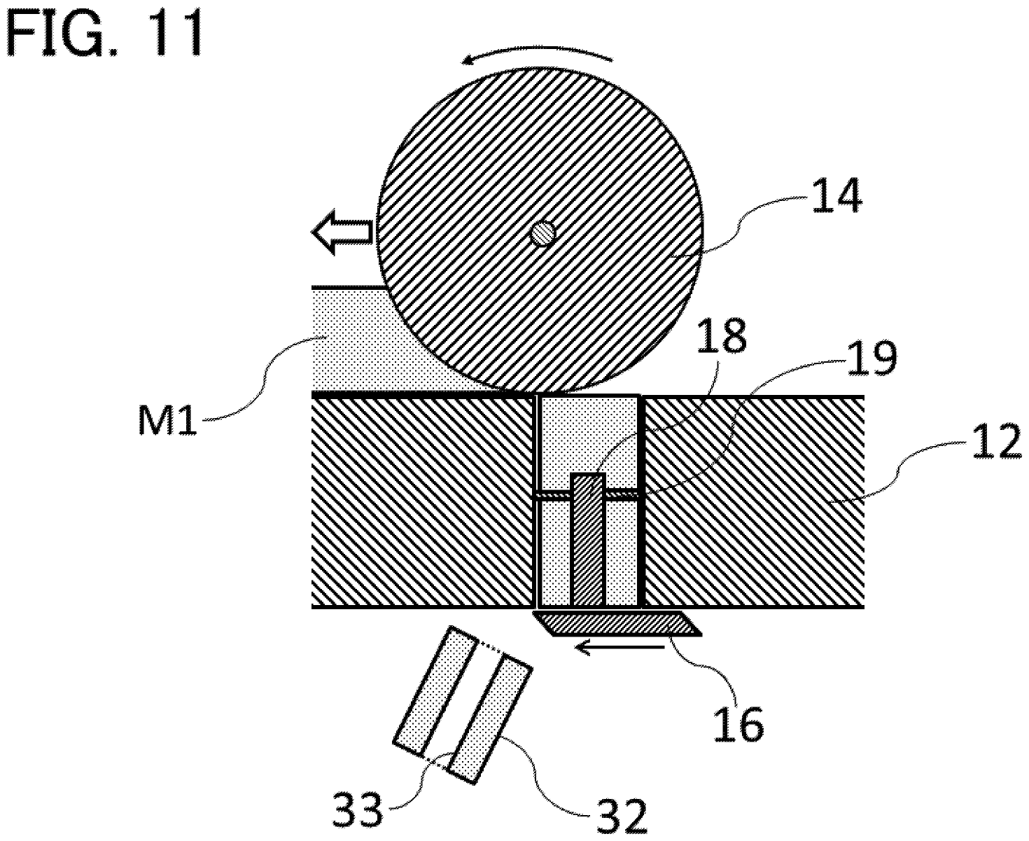

In the granulation step, as shown in FIG. 10, a granulation material M1 supplied to the front surface side of the die 12 is pressed into the die hole 13 by the roller 14 that rolls on the surface of the die 12. At this time, the granulation material M1 can pass only through a portion of the interior of the die hole 13 where the core member 18 is not provided. For this reason, a hole extending in a prolongation of the core member 18 is formed in the granulation material M1 extruded to the back surface side of the die 12. This hole will later serve as a through hole 33. On the back surface of the die 12, the cutter 16 continues to rotate. Accordingly, the granulation material M1 extruded from the die hole 13 is cut by the cutter 16 as shown in FIG. 11. A core portion 32 that has a through hole 33 is thereby obtained. The granulation material M1 cannot pass through a portion where the connecting member 19 is provided, but it does not substantially affect the shape of the granulation material M1 extruded to the back surface side of the die 12 because the width w1 and the thickness t1 of the connecting member 19 are sufficiently small.

The coating step is a step of forming a coating portion 34 by attaching a coating material to the surface of each core portion 32 formed in the granulation step. In the coating step, by using the coating machine 20 described above, a coating material is attached to the surface of each core portion 32. At this time, the coating material is attached to the inner face 33a of the through hole 33 so as not to close the through hole 33. Also, the coating material is attached to the entire inner face 33a of the through hole 33. A coating portion 34 is thereby formed. Then, post-treatment such as sieving and drying is performed as needed. Through the above processing, a water absorption treatment material 3 composed of a plurality of grains 30 is obtained.

Advantageous effects of the present embodiment will be described. In the present embodiment, a granule (core portion 32) that has a through hole 33 is formed. Accordingly, a grain 30 that has a surface area larger than that when the through hole 33 is not formed in the core portion 32 is obtained. As a result, the contact area of the grain 30 that comes into contact with a liquid is increased, and thus the water absorption speed can be improved. Accordingly, a manufacturing method and a manufacturing apparatus 1 for manufacturing a water absorption treatment material 3 that has an excellent water absorption speed are implemented. Also, forming a through hole 33 in each core portion 32 as described above is also advantageous in that the granulation material can be saved in an amount corresponding to the through hole 33.

In the present embodiment, the coating material is also attached to the inner face 33a of the through hole 33. Accordingly, the coating material can be spread over a wide area of the surface of the granule 32. By spreading the coating material that contains an adhesive material over a wide area, in the manufactured water absorption treatment material 3, grains 30 that have absorbed a liquid can be strongly bonded together. In particular, the coating material is attached to the entire inner face 33a of the through hole 33. With this configuration, the coating material can be spread over a wider area than the configuration in which the coating material is attached only partially to the inner face 33a.

An operation of attaching the coating material to the inner face 33a of the through hole 33 is performed such that the through hole 33 is not closed by the coating material. By doing so, a liquid path is secured in the through hole 33. This is advantageous in increasing the contact area between the liquid and the grain 30.

In the granulation step, the core portion 32 is formed using the granulation machine 10. Accordingly, a large number of core portions 32 can be formed in a short time.

In the granulation machine 10, the core member 18 is provided in the die hole 13. With this configuration, a through hole 33 is formed at the same time when the granulation material is molded into a granule, and it is therefore possible to easily obtain a core portion 32 in which a through hole 33 is formed.

The core member 18 is provided so as to extend only partially through the die hole 13 in the thickness direction of the die 12, and does not extend to the inlet opening surface of the die hole 13. In this case, the core member 18 is not present near the inlet of the die hole 13, and thus the granulation material can be pressed into the die hole 13 in an amount that is the same as that of when the core member 18 is not provided in the die hole 13. With this configuration, a high pressure can be easily applied to the granulation material when it passes through the region where the core member 18 is present.

The core member 18 extends to the outlet opening surface of the die hole 13. In this case, the granulation material passes through the region where the core member 18 is present until immediately before the granulation material is extruded from the die hole 13. Accordingly, it is possible to reduce the occurrence of a situation in which a hole once formed in the granulation material by the core member 18 is closed after the granulation material has passed through the region where the core member 18 is present.

In the case where the core portion 32 and the coating portion 34 contain an organic substance as the main material, it is possible to obtain a grain 30 suitable for being disposed of through incineration. In this case, a clump of used grains 30 can be discarded as combustible trash, and it is therefore possible to improve convenience for a user.

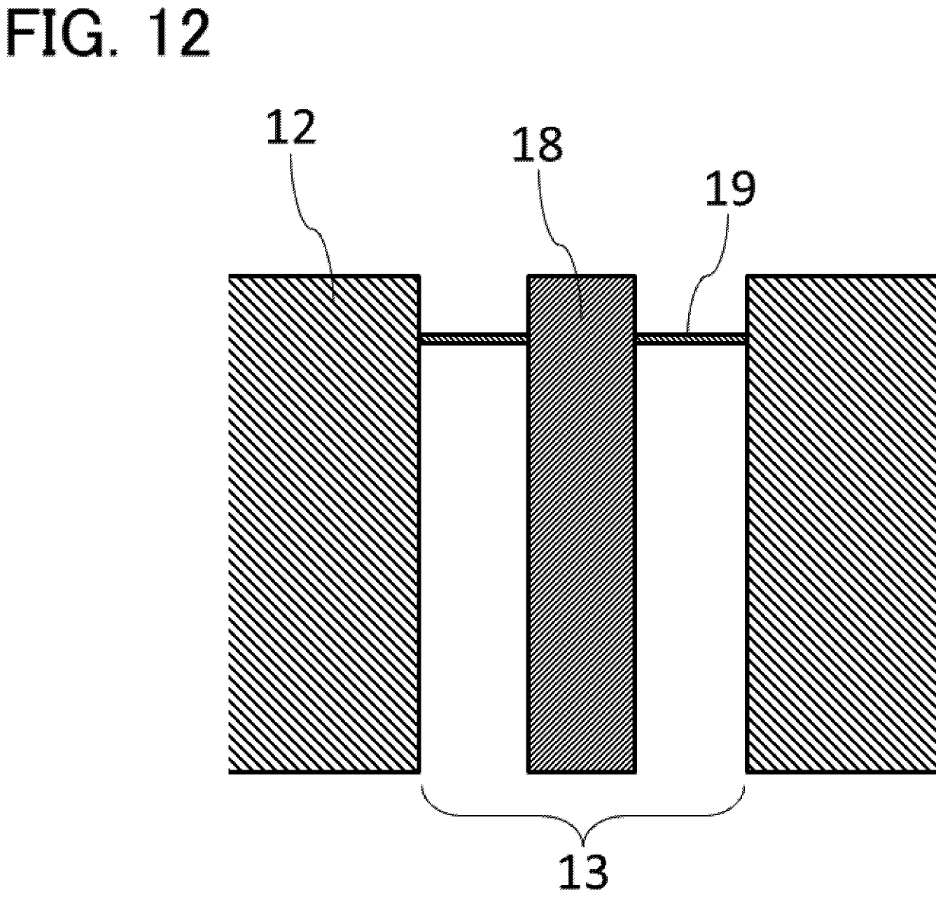

The present invention is not limited to the embodiment given above, and various modifications can be made. In the embodiment given above, an example has been described in which the core member 18 is provided so as to extend only partially through the die hole 13 in the thickness direction of the die 12. However, for example, as shown in FIG. 12, the core member 18 may be provided so as to extend entirely through the die hole 13 in the thickness direction of the die 12. The diagram shows the same end face as in FIG. 8.

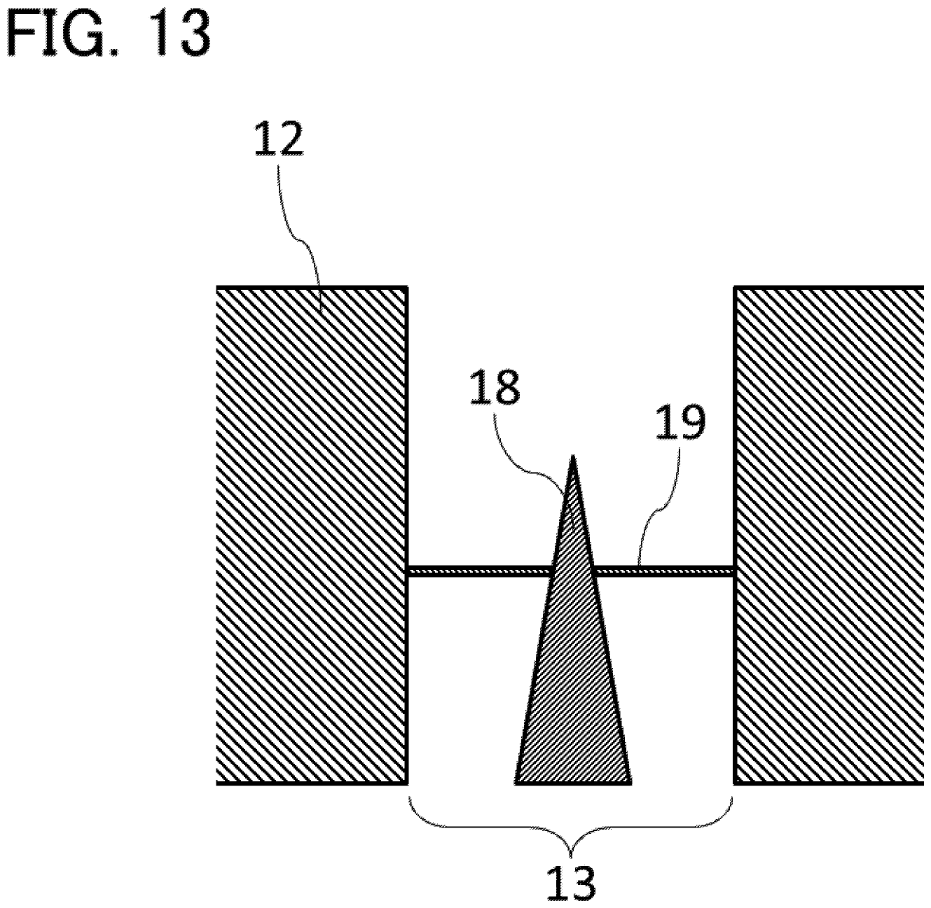

In the embodiment given above, an example has been described in which the diameter of the core member 18 is constant. However, for example, as shown in FIG. 13, the diameter of the core member 18 may increase monotonously from the inlet side toward the outlet side of the die hole 13. The diagram shows the same end face as in FIG. 8. In FIG. 13, the core member 18 has a tapered shape, and its diameter increases gradually from the inlet side toward the outlet side of the die hole 13. By forming the core member 18 to have a fine tip end as described above, the granulation material can smoothly pass through the die hole 13.

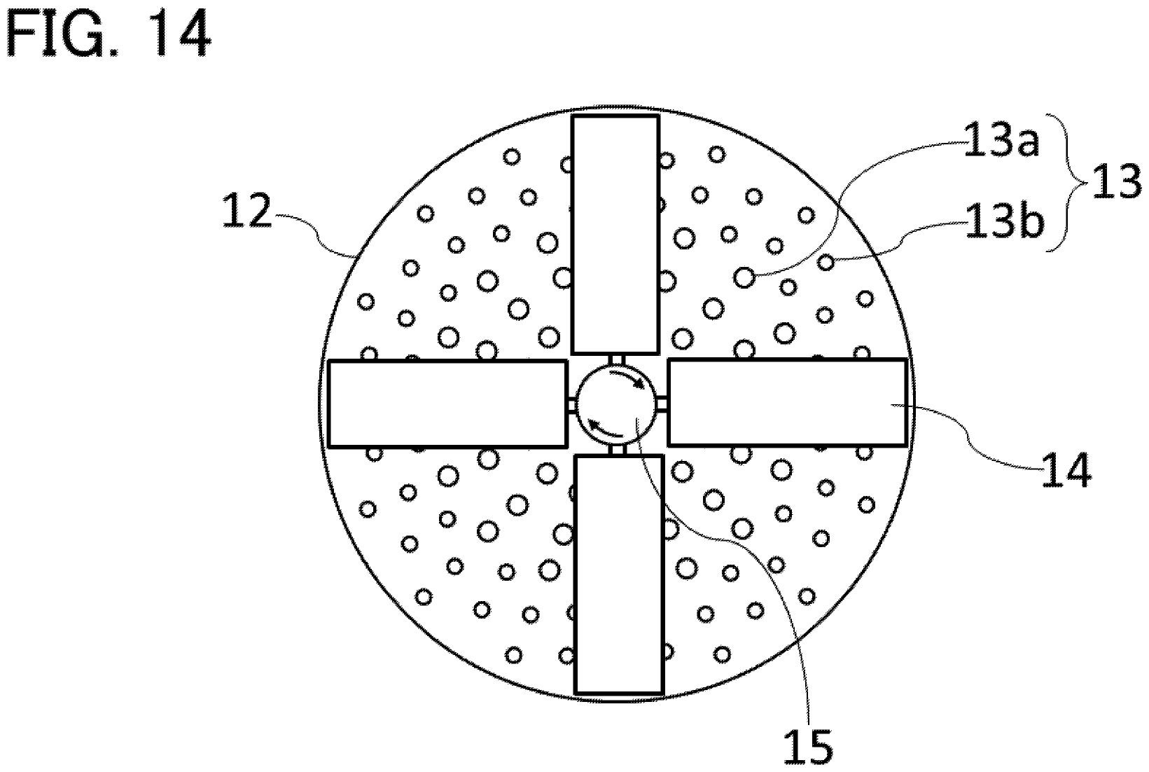

In the embodiment given above, an example has been described in which all die holes 13 formed in the die 12 have the same diameter. However, for example, as shown in FIG. 14, the plurality of die holes 13 may include die holes 13a (first die holes) and die holes 13b (second die holes) that have different diameters. The die holes 13a have a first diameter. Also, the die holes 13b have a second diameter that is smaller than the first diameter. The die holes 13b are provided on the outer side of the die holes 13a in the radial direction of the die 12. In other words, the die holes 13b are provided at positions farther from the rotation axis 15 than the die holes 13a are. Accordingly, the diameters of the plurality of die holes 13 decrease monotonously as they are located away from the rotation axis 15.

In the granulation machine 10, the granulation material is pressed into the die hole 13 by the roller 14 that revolves about the rotation axis 15. In the case of this configuration, the pressing force of the roller 14 pressing the granulation material is weakened as the position is away from the rotation axis 15. In other words, the pressing force of the roller 14 pressing the granulation material differs according to the distance from the rotation axis 15. Such difference in the force causes variation in the hardness of the resulting core portions 32.

In this regard, in FIG. 14, the die holes 13b are provided on the outer side of the die holes 13a in the radial direction of the die 12. If the strength of the pressing force pressing the granulation material is equal, the pressure applied to the granulation material increases as the diameter of the die holes 13 is smaller. For this reason, the die holes 13b that have a relatively smaller diameter are provided at positions relatively far from the rotation axis 15 (positions where the pressing force pressing the granulation material is relatively weak), and the die holes 13a that have a relatively large diameter are provided at positions relatively close to the rotation axis 15 (positions where the pressing force pressing the granulation material is relatively strong). With this configuration, variation in the hardness of the core portions 32 can be reduced.

In the embodiment given above, an example has been described in which a through hole 33 is formed at the same time when the granulation material is molded into a granule. However, the through hole 33 may be formed after the granulation material is molded into a granule. For example, after the granulation material has been molded into a cylindrical granule in the granulation step, a rod-shaped member may be penetrated through the granule along the central axis of the granule so as to form a core portion 32 that has a through hole 33. In this case, the core member 18 and the connecting member 19 are not provided in the die hole 13.

In the embodiment given above, an example has been described in which the coating material is attached to the entire inner face 33a of the through hole 33. However, the coating material may be attached only partially to the inner face 33a of the through hole 33. In this case, the remaining portion (the portion to which the coating material is not attached) of the inner face 33a of the through hole 33 is exposed. Alternatively, the coating material may not be attached to the inner face 33a of the through hole 33. In other words, the coating material may be attached only to a portion of the surface of the core portion 32 excluding the inner face 33a of the through hole 33. In this case, the entire inner face 33a of the through hole 33 is exposed. As a result of the inner face 33a of the through hole 33 being exposed as described above, a liquid can rapidly reach the core portion 32 through the exposed portion. Accordingly, the water absorption speed of the grain 30 can be further improved. In addition, when used grains 30 are disposed of in a flush toilet, the water in the toilet bowl can rapidly reach the core portions 32. The dissolubility of grains 30 in water is thereby improved, and it is therefore possible to achieve a water absorption treatment material 3 that can be easily disposed of in a flush toilet after use.

In the embodiment given above, an example has been described in which the through hole 33 is not closed by the coating material. However, the through hole 33 may be closed by the coating material.

In the embodiment given above, an example has been described in which the granulation machine 10 includes a roller 14. However, the granulation machine 10 does not need to include a roller 14. In this case, the granulation material may be pressed into the die holes 13 by a known means other than the roller 14.

In the embodiment given above, an example has been described in which the granulation machine 10 includes a cutter 16. However, the granulation machine 10 does not need to include a cutter 16. In this case, the granulation material extruded from the die holes 13 may be cut by a known means other than the cutter 16.

In the embodiment given above, an example has been described in which the granulation machine 10 is used to form core portions 32. However, it is not necessary to use a granulation machine to form the core portions 32. For example, the core portions 32 may be formed manually.

In the embodiment given above, an example has been described in which each core portion 32 has a substantially cylindrical tubular shape. However, each core portion 32 may have any shape as long as the core portion 32 has a through hole passing through the core portion 32. For example, each core portion 32 may have a spherical or elliptical shape in which a through hole is formed.

### LIST OF REFERENCE NUMERALS

1 Manufacturing apparatus

3 Water absorption treatment material

10 Granulation machine

12 Die

13 Die hole

13a Die hole (first die hole)

13b Die hole (second die hole)

14 Roller

15 Rotation axis

16 Cutter

18 Core member

19 Connecting member

20 Coating machine

30 Grain

32 Core portion (granule)

33 Through hole

33a Inner face

34 Coating portion

1. A method for manufacturing a water absorption treatment material that is composed of a plurality of grains, the method comprising:
a granulation step of granulating a granulation material, and thereby forming a granule that constitutes each of the grains; and
a coating step of attaching a coating material that contains an adhesive material to a surface of the granule formed in the granulation step, and thereby forming a coating portion that covers the surface of the granule,
wherein, in the granulation step, the granule that has a through hole that extends therethrough is formed.

2. The method for manufacturing a water absorption treatment material according to claim 1,
wherein, in the granulation step, the granule is formed using a granulation machine.

3. The method for manufacturing a water absorption treatment material according to claim 2,
wherein the granulation machine includes a die in which a die hole that allows the granulation material to pass therethrough is formed, and
a core member that extends along a central axis of the die hole is provided within the die hole.

4. The method for manufacturing a water absorption treatment material according to claim 3,
wherein the core member is provided so as to extend entirely through the die hole in a thickness direction of the die.

5. The method for manufacturing a water absorption treatment material according to claim 3,
wherein the core member is provided so as to extend only partially through the die hole in a thickness direction of the die.

6. The method for manufacturing a water absorption treatment material according to claim 5,
wherein the core member does not extend to an inlet opening surface of the die hole.

7. The method for manufacturing a water absorption treatment material according to claim 5,
wherein the core member extends to an outlet opening surface of the die hole.

8. The method for manufacturing a water absorption treatment material according to claim 3,
wherein a diameter of the core member increases monotonously from an inlet side toward an outlet side of the die hole.

9. An apparatus for manufacturing a water absorption treatment material that is composed of a plurality of grains, the apparatus comprising:
a granulation machine that granulates a granulation material and thereby forms a granule that constitutes each of the grains; and
a coating machine that attaches a coating material that contains an adhesive material to a surface of the granule formed by the granulation machine, and thereby forms a coating portion that covers the surface of the granule,
wherein the granulation machine forms the granule that has a through hole that extends therethrough.

10. The apparatus for manufacturing a water absorption treatment material according to claim 9,
wherein the granulation machine includes a die in which a die hole that allows the granulation material to pass therethrough is formed, and
a core member that extends along a central axis of the die hole is provided within the die hole.

11. The apparatus for manufacturing a water absorption treatment material according to claim 10,
wherein the core member is provided so as to extend entirely through the die hole in a thickness direction of the die.

12. The apparatus for manufacturing a water absorption treatment material according to claim 10,
wherein the core member is provided so as to extend only partially through the die hole in a thickness direction of the die.

13. The apparatus for manufacturing a water absorption treatment material according to claim 12,
wherein the core member does not extend to an inlet opening surface of the die hole.

14. The apparatus for manufacturing a water absorption treatment material according to claim 12,
wherein the core member extends to an outlet opening surface of the die hole.

15. The apparatus for manufacturing a water absorption treatment material according to claim 10,
wherein a diameter of the core member increases monotonously from an inlet side toward an outlet side of the die hole.

16. The apparatus for manufacturing a water absorption treatment material according to claim 10,
wherein the die is provided with a plurality of the die holes, and
the plurality of die holes include a first die hole that has a first diameter and a second die hole that has a second diameter that is smaller than the first diameter.

17. The apparatus for manufacturing a water absorption treatment material according to claim 16,
wherein the granulation machine includes: a rotation axis that is positioned at a center portion of the die; and a roller that presses the granulation material into each of the die holes while revolving about the rotation axis.

18. The apparatus for manufacturing a water absorption treatment material according to claim 17,
wherein the second die hole is provided at a position farther from the rotation axis than the first die hole is.

19. The apparatus for manufacturing a water absorption treatment material according to claim 9,
wherein the coating machine also attaches the coating material to an inner face of the through hole.

20. The apparatus for manufacturing a water absorption treatment material according to claim 9,
wherein the coating machine attaches the coating material to an inner face of the through hole so as not to close the through hole.
